(19) United States
(12) Patent Application Publication
(10) Pub. No.: US 2018/0240145 A1
(43) Pub. Date: Aug. 23, 2018

(54) SYSTEM AND METHOD FOR PROVIDING PREDICTIVE BEHAVIORAL ANALYTICS

(71) Applicant: Syntasa Inc., Herndon, VA (US)

(72) Inventors: Shahrokh Zargham, Rockville, MD (US); Sanjay Marwaha, McLean, VA (US)

(73) Assignee: Syntasa Inc., Herndon, VA (US)

(21) Appl. No.: 15/439,565

(22) Filed: Feb. 22, 2017

(51) Int. Cl. G06Q 30/02; G06N 99/00; G06N 5/02

(52) U.S. Cl. CPC G06Q 30/0241; G06Q 30/0226; G06N 5/022; G06N 99/005

(57) ABSTRACT

A method, and corresponding system implementing the method, determines analytics schema for interactions of users with an online channel, and includes: determining experiences for the users during the interactions based upon web analytics data and enterprise analytics data; determining a behavioral analytics schema for the users based on hierarchical data extraction analyses of the web analytics data through web analytics data analyses, and the enterprise analytics data through enterprise analytics data analyses; and reporting the behavioral analysis schema in response to a query. The method further includes: determining contexts for the users, a context being defined by attributes pertaining to the users; and the activities of the users, antedating the interactions of the users with the channel, where the behavioral analytics schema is further based on analyses of the contexts. The method also includes: determining outcomes for the users, an outcome being a defined result pertaining to the activities of the users following the experience determining step and prior to completion of the interactions for a given visit of the online channel, where the behavioral analytics schema is further based on analyses of the outcomes. In addition, the method includes: determining a predictive analytics schema for the users for predicting future interactions of the users with the online channel, the predictive analytics schema being based on application of learning processes to the behavioral analytics schema; and reporting the predictive analytics schema in response the query.

### TECHNICAL FIELD

The technical field described herein relates generally to computer networks and analyzing data, and more specifically to collecting and analyzing voluminous data.

### BACKGROUND

Enterprise BI (business intelligence) has arisen since the 1990's, when early disrupters sought to democratize access to big data and introduce BI to the masses. Enterprise BI platforms brought with them tremendous value, with the core concept of a centralized, shared data semantic, enabling user interaction with voluminous data without needing the comprehension of the underlying database structure or having to write their own SQL (structured query language). Upon the organization and semantic defining of the data, users were offered ad-hoc and predefined queries, and reporting and analyses via modules assembled from common components. The issue for enterprise, however, were the often excessive license fees and the high investment requirements for new platforms. Open source technologies commoditized fees, but the need for centralized IT for data organization defining a common semantic has continued to be an issue. There has been an increasing need for a decentralized structure, that is cost-effective yet capable of handling large volumes of data, without requiring excessive IT resources and fee commitments.

At the same time, major trends have developed to change user expectations at a core level, including: omnipresent, perpetual connectedness brought by telecom and globalization; a closeness to the technology itself as apps have replaced user manuals; immediate responsiveness brought by better software and faster hardware to the grass roots common user; and vast sharing and collaboration brought by social media, to redefine user expectations.

These trends have come hand-in-hand with the first commercial inception of the Internet in the early ‘90’s to worldwide adoption today. With this revolution of nearly unlimited data exchanges came the interest, then earnest business need to understand and market to customers. The field of web analytics was born, growing from log file analysis programs, hit counters and JavaScript tags in the mid-to-late 90's, to more sophisticated quantitative analysis brought by Google Analytics and in-page analytics in the mid-2000's, to today's developments in app analytics. With the tremendous volume of data exchanges across many platforms have come increasingly greater data challenges with their counterpart in rewards for business. The data is of such magnitude and complexity that the term “big data” has become commonplace to reference the data itself and the enormous challenges in providing meaning to the data. Big data has replaced traditional methods inadequate to accomplish the capture, storage, curation, sharing, searching, analysis, visualization, transfer, updating, querying and privacy tasks that lie ahead.

Commercial deployment of analytics seeks to garner meaningful information about such data to gain strength in the market and expand market share. The challenge for big data is to store, consolidate and analyze data to not only gain meaningful insight on macro and micro levels, but to develop algorithms to enable prediction of future trends. Enterprise business operating in the online retail space, for example, continually seek BI about potential and returning customers, but in the new paradigm of enterprise analytics and web/app analytics. They possess the real-world vested interest in determining how well their websites operate to bring user traffic, to convert users to customers, and to motivate them to return for additional purchases. They also possess an interest in enterprise BI analytics tools to enhance enterprise level performance of the same and additional measures, such as metrics for sales forecasts, revenue and cost information, project progress tracking, inventory level control, and human resources. The current measures lack however the ability to conduct sophisticated analyses and perform predictive modeling. In particular, there is a need for systems, methods, and modes for not only collecting, storing and analyzing such data, but also conducting analytical, behavioral, predictive determination and modeling, and particularly across a plurality of technological and marketing platforms, venues and channels.

### SUMMARY

An object of the embodiments is to substantially solve at least the problems and/or disadvantages discussed above, and to provide at least one or more of the advantages described below.

It is therefore a general aspect of the embodiments to provide systems, methods, and modes for collecting, analyzing and predicting user behavior of users across multiple platforms, venues and channels that will obviate or minimize problems of the types aforementioned and provide additional, enhanced analysis by virtue of predictive, behavioural analytics.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

A method, and corresponding system implementing the method, for determining analytics schema for interactions of one or more users with an online channel includes: determining experiences for the users for the interactions based upon at least one of: web analytics data, and enterprise analytics data; determining a behavioral analytics schema for the users based on hierarchical data extraction analyses of at least one of the web analytics data through web analytics data analyses, and the enterprise analytics data through enterprise analytics data analyses; and reporting the behavioral analysis schema in response to a query. The method may further include: determining contexts for the users, the contexts being defined by attributes pertaining to any one of: the users; and the activities of the users, antedating the interactions of the users with the channel, where the behavioral analytics schema is further based on analyses of the contexts. The method may also include: determining outcomes for the users, the outcomes being a defined result pertaining to the activities of the users following the experience determining step and prior to completion of the interactions for a given visit of the online channel, and where the behavioral analytics schema is further based on analyses of the outcomes.

In addition, the method may cover: determining a predictive analytics schema for the users predicting future interactions of the users with the online channel, the predictive analytics schema being based on application of learning processes to the behavioral analytics schema; and reporting the predictive analytics schema in response to any one of the query and yet another query. The method further includes embodiments where any one of determining the experience and determining the context includes determining in relation to the user metrics relating to at least one of: a previously visited channel; geographical location of the user; a marketing campaign of an entity marketing to the user; an advertising campaign of an entity marketing to the user; a paid search leading to access of the channel; an organic search leading to access of the channel; direct access of the channel; the device type employed to access the channel; the platform type employed to access the channel; any one of a date and a time of the visit of the channel; a loyalty program employed; an incentive program employed; the customer profile information of the user; and class information pertaining to the user.

In additional embodiments, the web analytics data analyses include determining web analytics information for the user during the interactions, where the enterprise analytics data analyses include determining an enterprise analytics information for at least one of the user and an enterprise entity related information. Also, the web analytics data may include at least one of: click data for the users; clickstream data for the users; page views data for the users; unique visitors data for the users; referral sources data for the users; bounce pages data for the users; site searching data for the users; and errors logged information for the users. The enterprise analytics information may also include at least one of: customer relationship management (CRM) data; emails data; enterprise resource planning data; loyalty programs data; incentive programs data; product inventories data; call centers data; location based information data; site area data; mobile apps data; interactive voice response (IVR) information data; products/services data; an ecommerce data; an information gathering data; and an inventory data.

In exemplary embodiments, the outcome includes determining at least one of: bounce of the user from the channel; browsing by the user of the channel; product views by the user on the channel; cart addition by the user on the channel; cart removal of the user on the channel; and purchase of a product by the user on the channel.

Determining the behavioral analytics schema for the users includes at least one of: (i) modeling the behavior of the users by tracing a clickstream data garnered from the web analytics analysis, the modeling including tracing each segment of the clickstream data, and each path including the entirety of the clickstream data, from the context to the experience and further to the outcome; (ii) modeling the behavior of the users by clustering the users into one or more cluster groups with each cluster group indicating any one of a buying behavior classification and a shopping behavior classification on the online channel, and further segmenting each cluster group based on the outcome; (iii) modeling the behavior of the users by performing the step (i) for additional channels and additional platforms; (iv) modeling the behavior of the users by segmenting parameters related to the outcome based on a time measurement, and mapping the segmented parameters based on any one of a volume of sales, a number of page views, and a number of product views, on the channel; (v) modeling the behavior of the users by mapping of (1) metrics relating to any one of the experience and the context, in relation to (2) another metric based on the outcome, this latter metric being at least one of a volume of sales, a number of page views, and a number of product views, on the channel; and (vi) modeling the behavior of the users by segmentation of a distribution of an entire population of the users based on factors relating to the outcomes, to enable conducting of algorithmic retargeting of the users based on the segmentation.

In exemplary embodiments, determining the predictive analytics schema in relation to any one of steps (i) through (vi) includes configuring and applying one or more learning models. Any one of the reporting of the behavioral analysis schema and the reporting of the predictive analytics schema may include a visualization via a graphical user interface of any one of steps (i) through (vi).

A system for determining analytics schema for interactions of users with an online channel is also provided. The system includes applications executed by processors, the applications including: applications operable to determine experiences for the users for the interactions based upon at least one of: web analytics data, and enterprise analytics data; applications operable to determine a behavioral analytics schema for the users based on hierarchical data extraction analyses of at least one of the web analytics data through web analytics data analyses, and the enterprise analytics data through enterprise analytics data analyses. A reporting device is also operable to report the behavioral analysis schema in response to a query.

In exemplary embodiments, the system also includes: applications operable to determine contexts for the users, the contexts being defined by attributes pertaining to any one of: the users; and the activities of the users, antedating the interactions of the users with the channel, wherein the behavioral analytics schema is further based on analyses of the contexts.

The system also covers: applications operable to determine one or more outcomes for the users, the outcome being a defined result pertaining to the activities of the users following the experience determining step and prior to completion of the interactions for a given visit of the online channel, where the behavioral analytics schema is further based on analyses of the outcomes.

It further includes: applications operable to determine a predictive analytics schema for the users predicting future interactions of the users with the online channel, the predictive analytics schema being based on application of learning processes to the behavioral analytics schema; and a reporting device operable to report the predictive analytics schema in response to any one of the query and another query.

In exemplary embodiments, any one of determining the experience and determining the context includes determining in relation to the user metrics relating to at least one of: a previously visited channel; geographical location of the user; a marketing campaign of an entity marketing to the user; an advertising campaign of an entity marketing to the user; a paid search leading to access of the channel; an organic search leading to access of the channel; direct access of channel; the device type employed to access the channel; the platform type employed to access the channel; any one of a date and a time of the visit of the channel; a loyalty program employed; an incentive program employed; a customer profile information of the user; and a class information pertaining to the user.

In exemplary systems, the web analytics data analyses include determining web analytics information for the user during the interactions, where the enterprise analytics data analyses include determining enterprise analytics information for at least one of the user and an enterprise entity related information. In exemplary embodiments, the web analytics data includes at least one of: click data for the users; clickstream data for the users; page views data for the users; unique visitors data for the users; referral sources data for the users; bounce pages data for the users; site searching data for the users; and errors logged for the users. In a certain exemplary embodiment, the enterprise analytics information covers at least one of: customer relationship management (CRM) data; emails data; enterprise resource planning data; loyalty programs data; incentive programs data; product inventories data; call centers data; location based information data; site area data; mobile apps data; interactive voice response (IVR) information data; products/services data; ecommerce data; information gathering data; and inventory data. In the system, the determining of the outcome may also include determining at least one of: bounce of the user from the channel; browsing by the user of the channel; product views by the user on the channel; cart addition by the user on the channel; cart removal of the user on the channel; and purchases of a product by the user on the channel.

In exemplary embodiments, the system implements a method of determining the behavioral analytics schema for the users, and includes at least one of: (i) modeling the behavior of the users by tracing a clickstream data garnered from the web analytics analysis, the modeling including tracing each segment of the clickstream data, and each path including the entirety of the clickstream data, from the context to the experience and further to the outcome; (ii) modeling the behavior of the users by clustering the users into one or more cluster groups with each cluster group indicating any one of a buying behavior classification and a shopping behavior classification on the online channel, and further segmenting each cluster group based on the outcome; (iii) modeling the behavior of the users by performing the step (i) for additional channels and additional platforms; (iv) modeling the behavior of the users by segmenting parameters related to the outcome based on a time measurement, and mapping the segmented parameters based on any one of a volume of sales, a number of page views, and a number of product views, on the channel; (v) modeling the behavior of the users by mapping of (1) metrics relating to any one of the experience and the context, in relation to (2) another metric based on the outcome, this latter metric being at least one of a volume of sales, a number of page views, and a number of product views, on the channel; and (vi) modeling the behavior of the users by segmentation of a distribution of an entire population of the users based on factors relating to the outcomes, to enable conducting of algorithmic retargeting of the users based on the segmentation.

Additional embodiments permit the system to determine the predictive analytics schema in relation to any one of the above items (i) through (vi) includes configuring and applying learning models. Any one of the reporting of the behavioral analysis schema and the reporting of the predictive analytics schema may also include visualization via graphical user interfaces of any one of the above items (i) through (vi).

### BRIEF DESCRIPTION OF THE DRAWINGS

The above and other objects and features of the embodiments will become apparent and more readily appreciated from the following description of the embodiments with reference to the following Figures, wherein like reference numerals refer to like parts throughout the various Figures unless otherwise specified, and wherein:

FIG. 1 illustrates is an overview of the inventive process for modeling interactions between a user and a platform/channel executing analytics processing according to certain embodiments;

FIG. 2 illustrates an exemplary contextual block diagram according to certain embodiments;

FIG. 3 is a block diagram illustrating an exemplary high level logical architecture according to certain embodiments;

FIG. 4A is a block diagram illustrating inventive integration of digital activity and enterprise data according to certain embodiments;

FIG. 4B is a block diagram illustrating an exemplary technology stack according to certain embodiments;

FIG. 5 is a block diagram illustrating a flow diagram for processing of user interactions according to certain embodiments;

FIGS. 6A, 6B, 6C, 6D and 6E respectfully illustrate multiple examples of path and segment analyses of clickstream data according to certain embodiments;

FIGS. 7A, 7B and 7C respectively illustrate paten and segment analyses of data via concentric ring visualizations;

FIGS. 8A and 8B respectively illustrate purchase segment and visual attribution analyses according to certain embodiments;

FIGS. 9A and 9B respectively illustrate clustering of datasets and visualization of such clustering according to certain embodiments;

FIG. 10 illustrates segmentation of users for meaningful abstractions useful for algorithmic retargeting according to certain embodiments;

FIGS. 11A and 11B illustrate multiple mappings of datasets on an interactive basis according to certain embodiments;

FIG. 12 illustrates an exemplary interactive mapping of a time to cart outcome according to certain embodiments;

FIG. 13 illustrates exemplary hardware and software platforms for the various embodiments; and

FIG. 14 illustrates an exemplary networking and telecommunications platform for the various embodiments.

### DETAILED DESCRIPTION

Introductory Considerations

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments can, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The following embodiments are discussed, for simplicity, in regard to the terminology and structure of a computer network such as the internet and usage by users of a webpage. However, the embodiments to be discussed next are not limited to these systems but can be applied to other fields such as sporting events, stock market behavior, the gaming industry, among others.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” or “in an embodiment” in various places throughout the specification is not necessarily referring to the same embodiment. Further, the particular feature, structures, or characteristics can be combined in any suitable manner in one or more embodiments.

Further still, it should be apparent to those of skill in the art that while certain items in the drawing Figures have been denoted “top,” “bottom,” “left side,” right side,” and the like, such spatial indicators are or can be arbitrary, and are done for the purposes of making it easier for the reader to understand and visualize the aspects of the embodiments and are not to be construed in a limiting manner.

Acronyms and Elements Described in the Figures

Table 1 provides a listing of certain acronyms of terms applicable to the embodiments.

TABLE 1

| Element | Description |
|---|---|
| 3G | Third Generation |
| 4G | Fourth Generation |
| App | Application, Executable Software Programming |
| | Code/Application |
| BT | Bluetooth |
| CD | Compact Disk |
| DVD | Digital Video Disk |
| GPS | Global Positioning System |
| GUI | Graphical User Interface |
| HDD | Hard Disk Drive |
| HDMI | High Definition Multimedia Interface |
| LTE | Long Term Evolution |
| NAD | Electronic Network Access Device |
| NFC | Near Field Communications |
| NW | Network |
| PC | Personal Computer |
| PED | Personal Electronic Device |
| RAM | Random Access Memory |
| ROM | Read-Only Memory |
| RW | Read/Write |
| USB | Universal Serial Bus (USB) Port |
| VGA | Video Graphics Array |

Exemplary Overview Embodiment

According to aspects of the embodiments, the problems described above can be addressed by methods (and corresponding systems implementing the methods) for modeling the past, present and future behavior of an individual user in his or her capacity, or a user which is a process in its capacity, of their respective interactions with one or more platforms, channels, or other hardware/software based venues. An example is an online interaction conducted on the Internet. Interactions are determined in individual capacity or in an aggregate capacity. Such modeling, in the form of behavioral analytics and predictive analytics (or “predictive behavioral analytics”) creates behavioral analytics and predictive analytics schema. The modeling is respectively based on collections of structured, semi-structured or unstructured data, in the form of web analytics, application (app) analytics and enterprise (or “enterprise class”) analytics data, processing of such data in real or substantially near real time, combining the collected data on about individual with entity data, such that hierarchical schema in the form of behavioral analytics schema and predictive analytics schema are developed.

Exemplary collected data, such as web analytics data in the form of clickstream data, as well as enterprise data about the user (or other enterprise relevant data), or a combination thereof with additional data sources, are consolidated in a behavioral/predictive analytics schema. In exemplary embodiments, massive amounts of data are collected and processed as “Big Data,” including in certain embodiments via usage of Apache™ Hadoop®, in original form or modified in accordance with the embodiments. As skilled persons appreciate, Apache™ Hadoop® comprises open-source software for reliable, scalable, distributed computing, and its software library is a framework that allows for the distributed processing of large data sets across clusters of computers using simple programming models.

According to certain aspects of the embodiments, the users are customers of products/services, and the inventive behavioral analytics analyzes customers’ experiences, their journeys through various channels such as webpage(s) executed on browsers of product/service providing business entities, and determines their behavioral traits. Existing and then new customers are segmented such that their propensity to reach a defined outcome can be predicted with a reasonable level of certainty. Businesses entities employing the inventive behavioral analytics include, for example, retailers, the media and entertainment industry, financial service suppliers and governmental or quasi-governmental enterprises and concerns.

Furthermore, systems and methods according to aspects of the embodiments capture one or more data points at differing stages during the interaction process that is of interest to the business entity offering its products/services. According to still further aspects of the embodiments, acquiring as much detailed information about the individual prior to entry into the entity network can produce higher quality results in terms of successfully predicting outcomes based on past behavior.

According to certain aspects of the embodiments, the inventive behavioral, advanced and predictive analytics increases customer satisfaction by enhancing the user's experience in the platform/channel, offering the customer the customer's preferential products/services, and making sales/returns simpler and generally more satisfying.

The inventive behavioral, advanced and predictive analytics accomplishes these results by, inter alia, collecting data regarding customer experiences, customer journeys and customer segments, determining outcome propensity scores, and determining the drivers of particular outcomes. As further described below, the technologies used in accomplishing the inventive predictive behavioral analytics include, among others, Big Data extract, transform, load (ETL), the aforementioned behavioral schema, path and sequencing analysis, and machine learning. In exemplary embodiments, the delivery of the behavioral, advanced and predictive analytics includes SaaS and enterprise level, on-premises, and other delivery methodologies.

Exemplary Embodiment to Analyze, Personalize and Realize

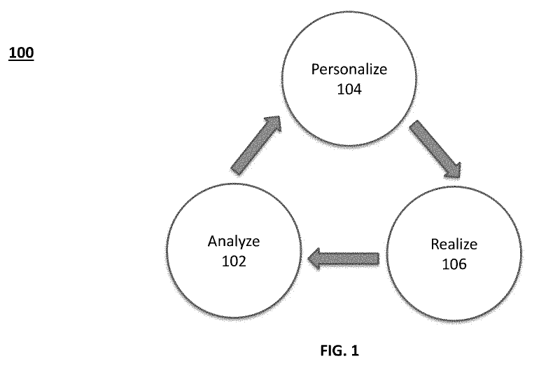

Turning to FIG. 1, illustrated is an overview of inventive process 100 for modeling interactions between a user and a platform/channel executing analytics processing resident or remotely from the platform/channel, according to aspects of the embodiments. Process 100 includes analyze subcomponent 102, personalize subcomponent 104 and realize subcomponent 106, respectively interacting in cyclical fashion.

As used herein, a user can be one or more customers in a commercial setting, and is not limited to human users, but also includes executed application or processes, or a combination of such machine based and human based interactions. Furthermore, while process 100 is illustrated in sequential, continuous fashion, it is not to be considered limited to such. In certain exemplary embodiments, the user is a visitor to a marketing and/or technology platform or channel.

In analyze portion 102, analysis of different classes/types/segments of data is performed. In exemplary embodiments, analyze portion 102 comprises (1) formatting/consolidating web analytics (e.g., clickstream) and enterprise data, and gathering such data; (2) consolidating the data for behavioral/predictive analytics; (3) advanced analysis and hierarchical processing of the behavioral/predictive analytics data; and (4) assembling and implementing behavioral/predictive models in the form of schema based on the foregoing. Exemplary detailed implementations are further described below.

In personalize subcomponent 104, personalized experiences are delivered to the user based on the analyses performed in analysis subcomponent 102. As noted, an exemplary user is a visitor of a platform/channel, which in an exemplary embodiment comprises a webpage (though platform/channel is not to be limited as such). Test experiences for the user are conducted. For example, for a given user or segment of users, one experience (an “A” experience) can be compared to another experience (a “B” experience) to determine which one leads to the more positive outcome. Targeted personalized campaigns are also be orchestrated for the user or segment of users. Exemplary detailed implementations are further described below.

In realize subcomponent step 106, value/benefit scenarios are realized for the user. Examples include (1) satisfaction/happiness of the customer user; (2) higher conversions of the user from a potential purchaser to an actual purchaser by increased downloads/sales on the platform/channel; (3) higher retention rates of visiting customers; and (4) increased sales during the present or future visits by users or customer segments. Based on these metrics, the data gathered is abstracted hierarchically, and fed back to analyze subcomponent 102 for predictive outcomes. Exemplary detailed implementations are further described below which include metrics collected about the user indicating interest during various stages of interactions and transactions.

Exemplary Contextual Block Diagram

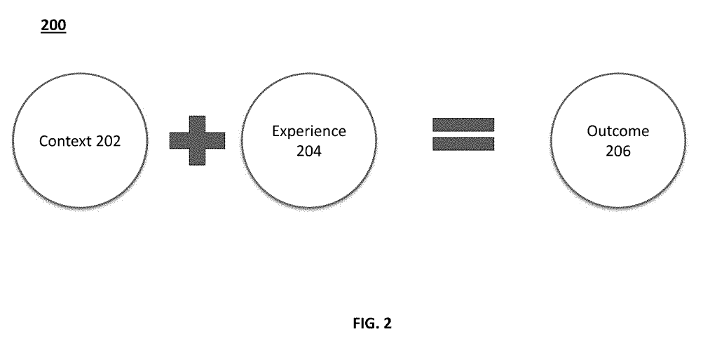

FIG. 2 illustrates an inventive contextual block diagram 200 of process 100, to demonstrate major interactive components according to certain aspects of the embodiments. In particular, the inventive analytics processing further described below provides a means for user context 202 plus the user's platform/channel experience 204 to equal the user's behavioral/predictive outcome 206.

In particular, context 202 references attributes, such as relevant metrics/data, of the user antedating or preceding in time and/or space, the user's initial visit to the platform/channel, or alternatively, in concert with the user's initial visit to the platform/channel. In reference to the user's context 202, exemplary attributes include: (1) previously visited channel(s); (2) geographical location; (3) marketing or advertising campaigns; (4) types of devices or platforms used (e.g., Safari browser executed on an iPhone, or a desktop personal computer (PC) on an enterprise virtual private network executing a proprietary application); (5) the date or time of the interaction; (6) loyalty or incentive programs employed; and (7) customer profile information pertaining to the particular user (e.g., IP address, physical address, web browser used) or class of users (e.g., demographic information). Additional attributes are attributes noted below in reference to experience 204. In exemplary embodiments, such attributes are classified, categorized and/or stored in a hierarchical fashion.

Experience 204 references the user's interactions that logically take place on or in relation to the platform/channel, that follow context 202 or alternatively are concurrent with context 202. These interactions need not be physically on the platform/channel; either resident memories and/or processors (e.g., apps), or remotely located memories and/or processors working together in concert, can be used in alternative embodiments. Relevant data parameters are garnered, analyzed and/or processed. In exemplary embodiments, in reference to a customer user, this information includes (1) web analytics metrics/data; (2) enterprise class analytics metrics/data; (3) behavioral and/or predictive analytics metrics/data derived about or in relation to the user during the user's visit of a platform/channel; and (4) a combination of the foregoing items (1), (2) and (3). In exemplary embodiments, such metrics/data are classified, categorized and/or stored in a hierarchical fashion.

Exemplary web analytics metrics/data include metrics/data comprising or relevant to: (1) clicks and/or clickstream data for users; (2) page views by users; (3) the number of unique visitors visiting the platform/channel; (4) referral sources; (5) bounce pages; (6) site searching; and (7) errors logged, among others. Exemplary enterprise analytics metrics/data include metrics/data comprising or relevant to: (1) CRM (customer relationship management); (2) emails; (3) enterprise resource planning; (4) loyalty/incentive programs; (5) product inventories; (6) call centers; (7) location based information, including kiosk or in-store visitation data; (8) site area; (9) mobile apps; (10) IVR (interactive voice response) information; (11) products/services; (12) ecommerce or information gathering; and (13) inventory data, among others. Additional attributes are attributes noted above in reference to context 202.

Exemplary behavioral and/or predictive analytics metrics/data include metrics/data comprising or relevant to processing and/or analyzing the foregoing web analytics and/or enterprises class data to derive higher level metrics; examples include metrics/data comprising or relevant to: (1) customer experiences; (2) customer journeys; (3) customer segments; (4) outcome propensity scores; and (5) driver outcome data, among others.

Outcome 206 references the behavioral or predictive analytics results determined from the user's visit of the platform/channel; this includes not only results from a single user during a single visit, but any combination of more than one user, or class of users, during one or more visits, or class of visits. In exemplary embodiments, such metrics/data are classified, categorized and/or stored in a hierarchical fashion.

For example, in reference to an exemplary customer user in the context of one or more Internet online retail platforms/channels, exemplary outcomes include (1) registration of the user; (2) downloads by the user; (3) additions to an online cart by the user; (4) actual purchase of items in the user's cart; (5) removal of an item from the user's cart; (6) cancellation of an order; and (7) return of a purchased item.

In exemplary embodiments, hierarchies are set from, or derived from, such outcomes. In an exemplary such embodiment, a hierarchy is generated relating to the economic value of the customer user to the persons or business entities (collectively “entities”) who own or otherwise control the platform/channel, for past, present visit and potential future visits to the platform/channel; an exemplary such hierarchy comprises: (1) users who have made a purchase with no returns or cancellations (following adding the item to the online shopping cart), and have also made previous purchases on the platform/channel (i.e., the highest ranked user); (2) users who have made a purchase with no returns or cancellations (following adding the item to the online shopping cart), who are new visitors to the platform/channel; (3) users who have made a purchase but returned the item purchased or cancelled the transaction (following adding the item to the cart); (4) users who have placed an item in the cart, but removed it from the cart, with no purchase; (5) users who have made downloaded information, but have not added an item to the cart; (6) users who have performed none of the foregoing actions (1)-(5), but who stayed on the platform/channel for a predetermined period of time; and lastly (7) users who have performed none of the foregoing actions (1)-(5), but failed to even stay on the platform/channel for the aforementioned predetermined period of time (i.e., the lowest ranked user).

Exemplary High Level Logical Architecture

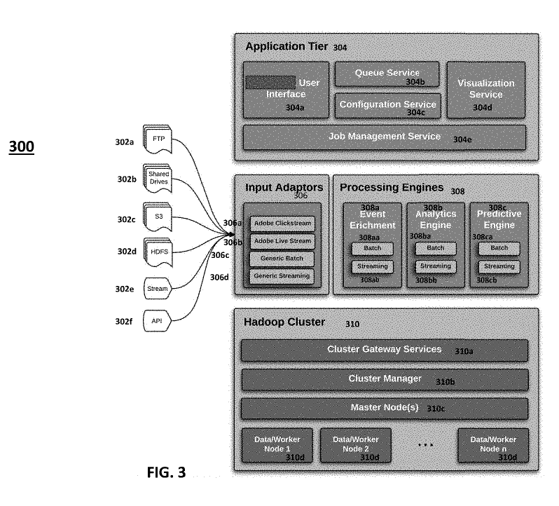

FIG. 3 illustrates exemplary high level logical architecture 300, particularly shown as a number of functional application modules. In an exemplary embodiment, these and other such modules illustrated and described herein, comprise one or more processes implemented by software, hardware, whether resident or remote, or a combination of the same, though the inventive embodiments and are not to be taken as limited to such. In particular, architecture 300 includes inputs 302, application tier 304, input adapters 306, processing engines 308 and Hadoop® clusters 310.

Application tier 304 contains the required components to support user interactions and to control application function. As shown, application tier 304 includes user interface 304a to support user input/output. It also includes components 304b-304e to control the application function. The latter includes queue service 304b for queuing jobs, configuration service 304c for setting and changing the system parameters, visualization service 304d for the visual communication and representation of data, and job management service 304e to manage and control jobs at the application tier 304. In an exemplary embodiment, user interface configuration and change management is performed, including: (1) automatically discovering report suites schema using web analytics APIs; (2) allowing users to assign business labels; (3) configuring behavioral/predictive schema to consolidate interaction and enterprise data; (4) detecting and showing web analytics configuration changes; (5) validating configuration changes to ensure error free deployments; (6) deploying configuration changes to production; (7) archiving previously deployed configuration and rollback in case of failures; (8) managing multiple report suites and/or datasets for multi-channel analysis; and (9) enabling users to build and maintain tabular datasets for reporting and analytics.

Input adapters 306 receive various inputs 302 and submit such inputs to processing engines 308. Input 302 are provided in a plurality of formats and systems. Examples include inputs from sources such as file transfer protocol FTP 302a, shared drives 302b, Amazon S3 (Simple Storage Service) 302c, HDFS (Hadoop® Distributed Files System) 302d, stream 302e and API 302f (application programming interface). Input adaptors 306 receive and process the received data in multiple formats. Exemplary formats include clickstream 306a, live stream 306b, generic batch 306c and generic streaming 306d formats.

Processing engines 308 process the data, and provide the processed data via data pipelines to Hadoop Cluster 310. In particular, the adapted data is processed by numerous methods, including event enrichment processing, analytics processing and predictive processing. In alternate embodiments, data is processed on batch, streaming and/or combination of batch/streaming bases. The processing pipelines in particular include: event enrichment engine 308a comprising batch enrichment engine 308aa and streaming enrichment engine 308ab; analytics engine 308b comprising batch analytics engine 308ba and streaming analytics engine 308bb; and predictive engine 308c comprising batch predictive engine 308ca and streaming predictive engine 308cb.

Hadoop Cluster 310 performs data storage and data processing. In particular, the data is submitted to Hadoop® cluster 310. Hadoop® cluster 310, including its components cluster gateway services 310a, cluster manager 310b, master nodes 310c, and data/worker nodes 310d, perform the core functions of data storage and data processing under YARN (Yet Another Resource Negotiator) which split up the functionalities of resource management and job scheduling/monitoring into separate daemons.

Exemplary Integration of Digital Activity and Enterprise Data

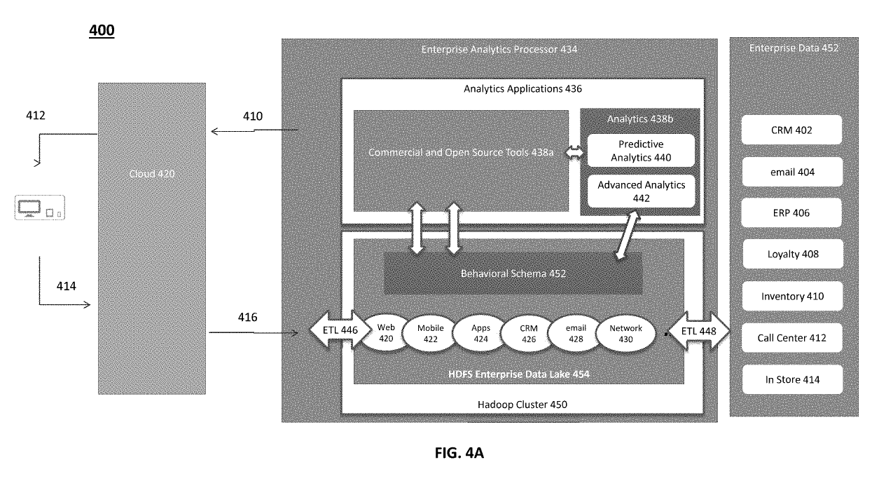

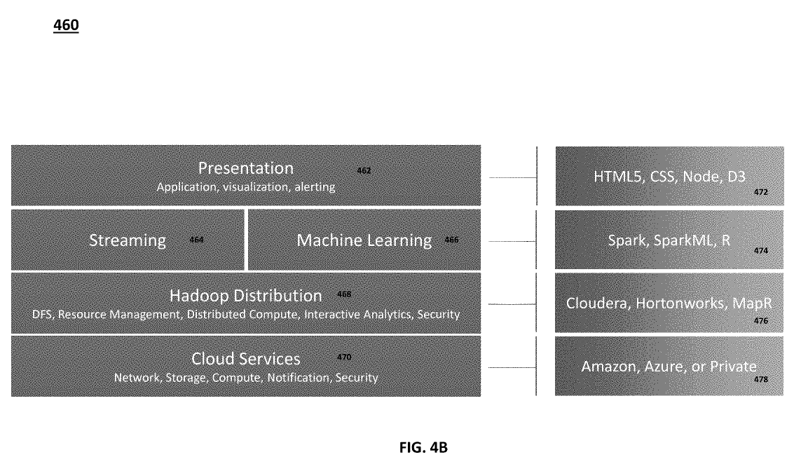

FIG. 4 is a block diagram illustrating inventive integration of digital activity (e.g., web analytics) and enterprise data according to an exemplary embodiment. System 400 includes cloud 420, enterprise analytics processor 434 and enterprise data 452.

Enterprise analytics processor 434 includes two main components, namely analytics applications 436 and Hadoop cluster 450. Analytics applications 436 comprises two component applications, commercial and open source tools 438a and analytics application 438b, the latter in-turn comprising predictive analytics application 440 and advanced (behavioral) analytics application 442. Advanced analytics application 442 and predictive analytics application 440 perform analytics processing of (1) user context 202 data, (2) user platform/channel experience 204 data (derived from web analytics data 416 and/or enterprise data 452), and (3) user outcome experience 206, and/or (4) any combination of (1) through (3).

In an exemplary embodiment where the platform/channel is a browser application executed on a client PC, for example, enterprise analytics processor 434 conducts a web analytics function. It receives and records all of the activity that occurs from the moment the user enters or accesses an entity's webpage, until the moment the user leaves or closes the browser. Here, each click or link through a user interface is recorded and time-date stamped; this information is received in relevant format (e.g., as clickstream data) and is then provided to either or both of commercial/open source analysis tools 438a and analytics application 438b, working in concert with Hadoop cluster 450 for Big Data processing and storage. In the illustrated example, a cloud-based server performs certain of the web analytics functions; as illustrated, the user's attributes are uploaded to a Cloud server 420 (e.g., Adobe Marketing Cloud) via relevant APIs 410 (e.g., AAM (Adobe audience manager) API; Core Services API), where the user's activities during his/her journey on the site 412 are tagged and logged 414; the relevant determined information (e.g., clickstream data) is downloaded to enterprise analytics processor 434 via reporting APIs 416 (e.g., Adobe Report Suite API; Adobe Live Stream API), where applications 436, 450 perform the aforementioned processing. In exemplary embodiments, the user activity is tagged in order to collect clickstream data, and the activity is stored in datasets organized for digital analytics. The datasets can be complex structures with customizable columns, with information including clickstream records, transactions, content and events being stored for ready access. In exemplary embodiments, the Hadoop cluster 450 described below is used for data ingestion, perform transactions and conduct enrichment of activity data.

As used herein, the term entity refers to any entity which owns or has rights to the platform/channel, including without limitation, a private or public entity, a commercial enterprise (e.g., an online retailer), governmental enterprise, or affiliation of companies.

In exemplary embodiments, commercial/open source analysis tools 438a comprises, without limitation, business intelligence, reporting, statistical analysis and/or machine learning applications. Tools 438a work in concert with analytics applications 438b and Hadoop cluster 450, as further described below.

In exemplary embodiments, behavioral (advanced) analytics is performed via advanced analytics application 442 working in concert with behavioral Hadoop cluster 450. The advanced behavioral analytics performed include defining a behavioral model, including by or based on: (1) user context 202 data, (2) user platform/channel experience 204 data, (3) user outcome, or (4) a combination of (1)-(3). In exemplary embodiments, behavioral analytics schema include: (1) enabling users to perform self-service data discovery, and building and sharing dashboards; (2) performing interactive path analysis; (3) analyzing intra-session journeys for users based on experience groups; (4) analyzing cross-session and/or cross-channel customer journeys based on session outcomes; (5) building customer 360 dashboards showing behavioral data; and (6) performing visual attribution based on user multi-session journeys.

In certain additional exemplary embodiments, predictive behavioral analytics is performed via predictive analytics application 440 working in concert with behavioral Hadoop cluster 450. Predictive behavioral analytics as performed includes predicting outcomes based on a behavioral model; again, the behavioral model can also be based on: (1) user context 202 data, (2) user platform/channel experience 204 data, (3) user outcome, or (4) a combination of (1)-(3). In exemplary embodiments, predictive analytics schema and related activities include: (1) creating and updating user-defined training databases; (2) defining supervised and unsupervised predictive models; (3) scoring visitors and customers to the platform/channel based on their propensity to reach a desired outcome; (4) building customer/visitor segments based on their behavior; (5) interfacing with external systems to enable predictive models to be semi- or fully-automated; (6) identifying drivers of customer purchases; (7) building customer level statistical attribution models; and (8) performing visual attribution based on user multi-session journeys.

Hadoop cluster 450, is configured, provisioned and tuned for the workload, and includes HDFS enterprise data lake 454 and behavioral (and/or predictive) schema 452. Data lake 454 includes storage of analytics data (e.g., web analytics data or app analytics data) loaded by ETL 446 from input data 416 from cloud 420, including exemplary web 420, mobile 422 and apps 424 data. Data lake 454 also includes storage of enterprise data loaded by ETL 448 from the enterprise, including exemplary CRM 426, email 428 and local network 430 data. HDFS data lake 454 stores data 420-430 in their natural format to facilitate the collocation of the data in various schemata/structural forms. In Hadoop cluster 450, the modules use Hadoop Common (not shown) libraries and utilities for file system and operating system (OS) level abstractions.

In an exemplary embodiment (not shown) web analytics data 416 and/or enterprise data 452 are stored and processed on enterprise analytics processor 434 via relational database management systems (RDBMS) coupled to enterprise data warehouses (EDW) using ETL (extract, transform and load) or ETLT (extract, transform, load, transform) application tools. Here, the ETL, and/or ETLT, extracts data from numerous sources, and then cleanses, formats, and loads the data into the EDW for analysis.

In an exemplary embodiment (shown) an Apache Hadoop open-source framework is used for distributed storage/processing, which comprises Hadoop clusters 450. The ETL ETL or ETLT functions are performed by Hadoop MapReduce (not shown). In particular, management of the computing resources across the clusters and scheduling of the applications is performed via a Hadoop YARN MapReduce platform. (In addition to MapReduce, other systems, such as the Apache Hive Data Warehouse (not shown) are used in alternative embodiments.)

Additional functions performed include event processing, including in exemplary embodiments: (1) ingesting hit files in HDFS enterprise data lake 454 and creating Hive tables; (2) cleansing records (applying site-specific filters); (3) sessionizing; (4) removing duplicates; (5) removing bots (requiring lookup files); (6) unpacking web analytics events and converting them to metrics; (7) enriching data based on web analytics classification tables; (8) enriching data based on enterprise data; and (9) managing non-web analytics event data using generic event input adapters.

FIG. 4B illustrates a software architectural view, in particular a view of an exemplary technology stack 460. Stack 460 illustrates the technology stack on the left, with corresponding specific implementations according the embodiments on the right. In the illustrated embodiment, the stack includes presentation layer 462 (application, visualization, alerting), overtop streaming layer 464 and machine learning layer 466, overtop Hadoop distribution layer 468 (distributed file system (DFS), resource management, distributed compute, interactive analysis and security), overtop cloud services layer 470 (network, storage, compute, notification and security). The corresponding specific implementations on the right of the figure include: HTML/CSS/Node/D3 472 applications 472 which are exemplary implementations of the presentation layer 462; Spark/SparkML/R applications 474 which are exemplary implementations of the streaming 464 and machine 466 layers; CLOUDERA/Hortonworks/MapR applications 476 which are exemplary implementations of the Hadoop distribution layer 468; and Amazon/Azure/Private applications 478 which are implementations of the cloud services layer 470. In one such exemplary embodiment, a cloud service 470 (e.g., Amazon) is used to provide Hadoop distribution function 468 (e.g., Hadoop Infrastructure as a Service, via Elastic MapReduce (EMR)); here, the Hadoop application function (e.g., EMR) provides the API that run and also provisions the Hadoop cluster 450 infrastructure; jobs may be run through the presentation layer 462. Hadoop can, for example, be provided as a service (e.g., Adobe's Genie), where separate jobs (e.g., Hadoop, but also Hive and Pig) are submitted (e.g., via REST-ful) through a higher level of abstraction without the need to provision additional Hadoop clusters 450. In alternative embodiments, Hadoop distribution 468 runs on runs on numerous commodity hardware in the cluster, which also function for fault-tolerance and access to large datasets by high throughput.

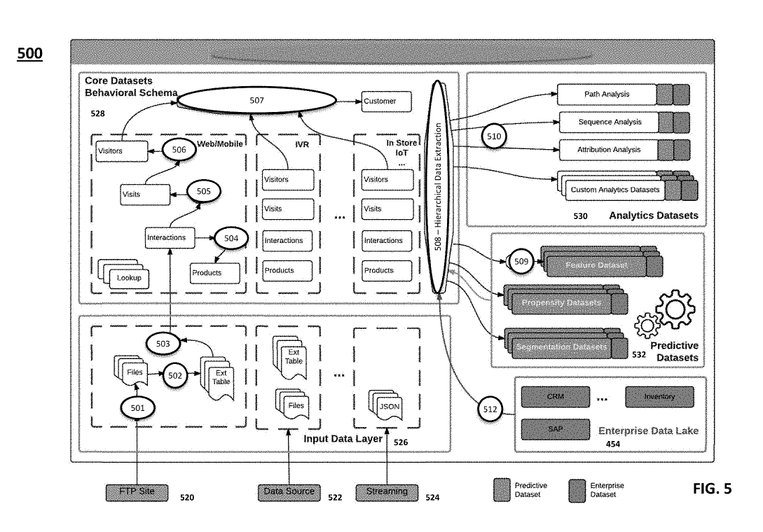

FIG. 5 illustrates an exemplary flow diagram 500 for processing of user interactions. Diagram 500 includes user interaction data provided by exemplary FTP site 520, data source 522 and from streaming source 524, which are input 501 to data layer 526. The data is loaded into files and processed, including with the use of configurable files and extensions 502 and piped output as processed data 503, which in-turn is transmitted to core datasets behavioral (and/or predictive) schema abstraction layer 528.

Here, data 503 is received and recorded as interactions data 505, combined with additional data 504 (e.g., about products) and with extraction of information, such as about the visits made by users 505, and the user visitors themselves 506, to yield collection of combined data 507. The combined data 507 includes data from multiple sources, such as from exemplary web/mobile, IVRs (Interactive Voice Response) and in-store IoT (Internet-of-things) applications and interfaces. A hierarchical extraction 508 is conducted for combined data 507. Enterprise-level data 512, e.g., CRM (customer relationship management), SAP (Systeme, Anwendungen, Produkte, German for Systems, Applications and Products) and inventor data, are provided from enterprise data lake 454 as input to the hierarchical extraction application 508. The outputs from the hierarchical extraction 508 include behavioral schema 452 data, which in the illustrated embodiment of FIG. 5 includes: (1) behavioral analytics 510 via analytics data sets 530, such as path analysis, sequence analysis, attribution analysis and customer analytics datasets; and (2) predictive analytics 509 via predictive data sets 532, such as feature datasets, propensity datasets and segmentation datasets.

Exemplary Behavioral and Predictive Analytics Schema

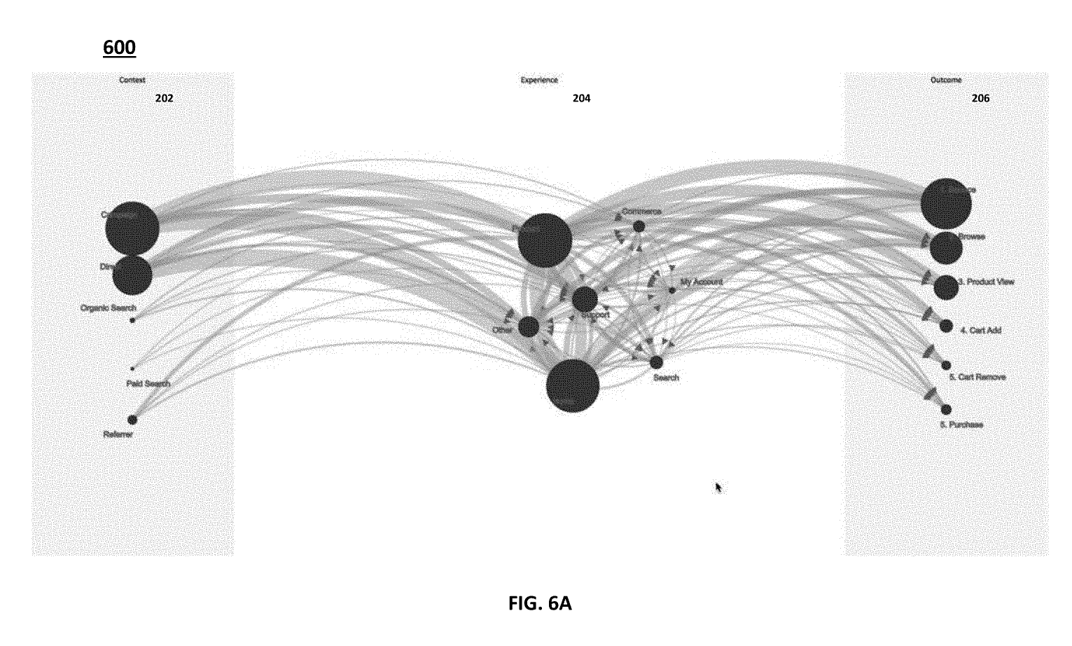

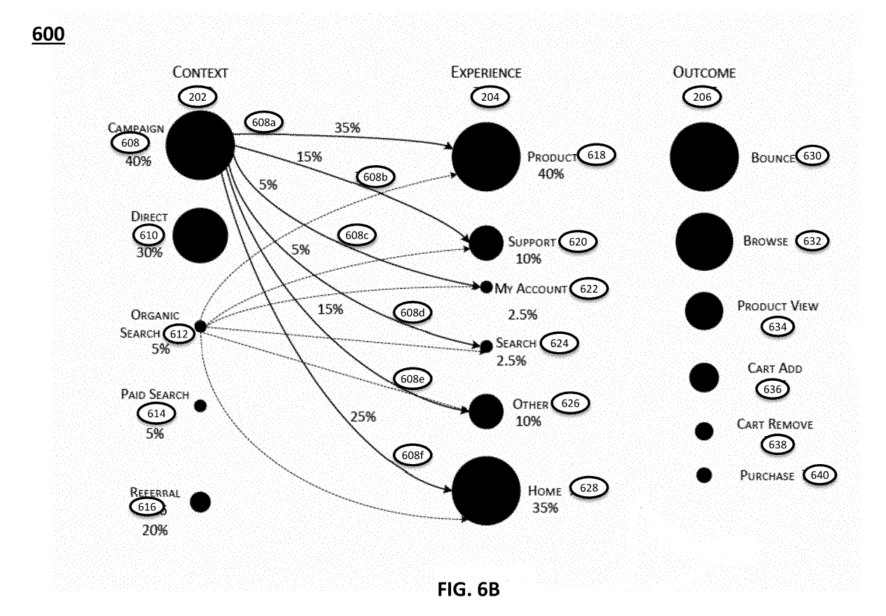

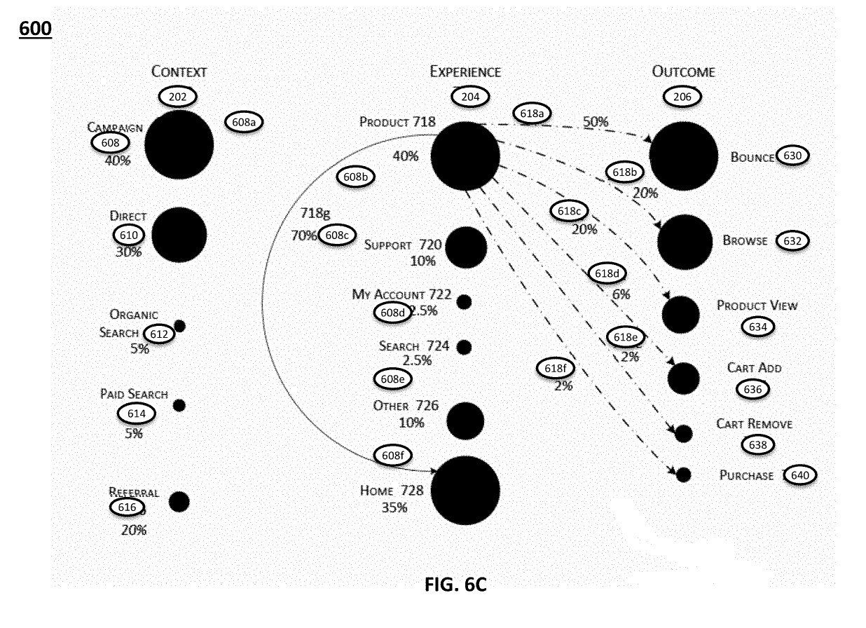

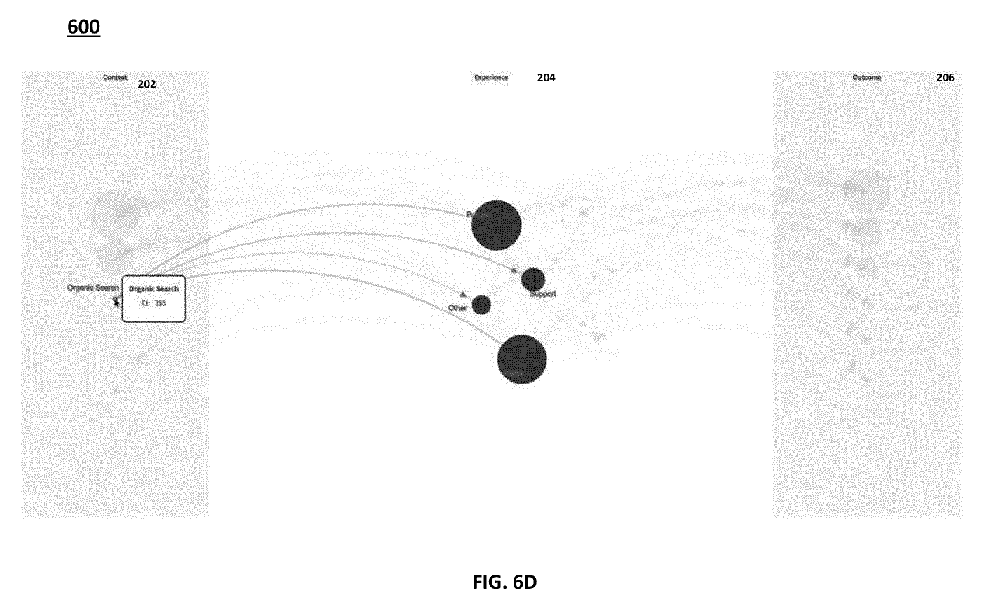

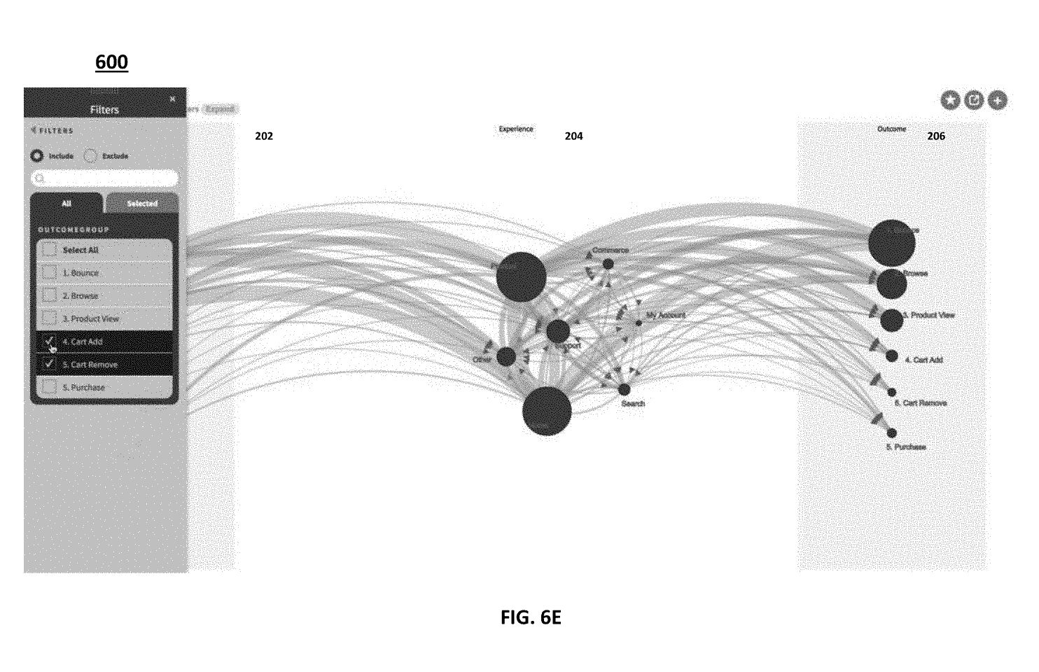

FIGS. 6A-6E illustrate path and segment analysis diagram 600 for an exemplary behavioral/predictive analytics schema of clickstream data. In the particular illustrated embodiment, in response to input by a user, such as a data scientist (or any other user), the information may be output by a GUI interface.

In reference to FIG. 6A, the output diagram shows how the context 202 of commercial customers visiting an entity's website (or any other user) is related to the experience 204 of these visitors, and in-turn to the outcome 206 for these visitors. In the particular example shown, the context of the visits, namely information about the visitors (hereinafter “users”) includes the following nodes: (1) campaign—a marketing/channel campaign which fed the users to the website; (2) direct—a direct landing by the users on the website (e.g., users typed the website address in their browsers); (3) organic search—a search via an organic search engine caused the users to land on the website (e.g., search performed on Google); (4) paid search—advertisements run on search engine sites landed users (e.g., Google AdWords campaign); referrer—a referring website referred the users (e.g., a direct link from a blog, or banner ads run on other sites).

Experience 204 includes the visitor users' experiences on the entity's platform/channel, which in the illustrated example is the entity's commercial website. As shown, the users' experiences include visits to/from the following nodes: a product page; a commerce page; a support page; a “my account” page; a home page; a search conducted on the website itself; and platform/channel; and an “other” category for a category not above listed. In the illustration, the lines between nodes indicate the amount of user traffic via their relevant, proportional thicknesses, and the size of the nodes themselves indicate proportionally the number of users having visited a given node.

Outcome 206 includes nodes indicating the users' last experience on the entity's website, as a measure of the value brought by these users as past, present or potential customers. The listed categories include, in hierarchical fashion: a bounce of the users—the users leave the website without additional browsing; a browse—users stay on the website and browse, but do nothing more; product view—users who browse long enough to view a product page; cart add—users who browsed, and ultimately added a product item to the cart, but did nothing more; cart remove—users who once having added a product to the cart removed it without making a purchase; and purchase—users who after having added the product to the cart, made a purchase. Based on the hierarchical relationships between nodes of a particular category (i.e., context 202, experience 204 and outcome 206), and between the nodes of different categories, behavioral and predictive analytics schema are derived. A discussion of exemplary schema are provided hereinabove, in reference to contextual block diagram 200 (FIG. 2).

FIGS. 6B and 6C are graphical illustrations of the above concepts, particularly illustrating garnering of information on a path-by-path or segment-by-segment basis. In FIG. 6A, the context 202 is labeled as campaign 608, direct 610, organic search 612, paid search 614, and referral 616; the relative sizes of the nodes indicate what percentage of users originate from each context (e.g., 40% of users arrive from a campaign; 30% of users arrive by direct access; 5% of users find the webpage based on an organic search; 5% of the users find the webpage based on a paid search; and 20% of the users find the webpage based on a referral).

Of users who have found one of the entity's webpages due to campaign 608, path 608a indicates that 35% arrive at product page 618 of the website: path 608b indicates that 15% arrive at support page 620 of the website; path 608c indicates that 5% of the users arrive at their my account page 622 of the website; path 608d indicates that 5% of the users arrive at the search function 624 of the website; path 608e indicates that 15% of the users arrive at “other” portions 626 of the website; and path 608f indicates that 25% of the uses arrive at home page 628 of the website. In fact, according the embodiments, any number of paths/segments journeys, between context 202, experience 204 and/or outcome 206 nodes, and between the nodes of any particular category, are illustrated in response to queries.

Given the very large number of possibilities, the analysis and illustration in diagram 600 can become very complex and involve high data throughput and intensive processing of data. For example, the size of the nodes shows the relative usage as different users visit the website from different all context areas 202; here, 40% of the users have landed on the product section 618; 10% have landed on the support page 620; 2.5% have landed on the my account page 622; 10% have visited other portion 626; and 35% have visited the home page 628 of the website.

Similarly, FIG. 6C illustrates the exemplary paths from experience 204 to outcome 206, for the particular example of users who have visited on the product page; here, 50% of these visitors 618a have a bounce outcome; 20% of these visitors 618b have a browse outcome; 20% of these visitors 618c have a product view outcome; 6% of these visitors 618d have a cart add outcome; 2% of these visitors 618e have a cart remove outcome; and 2% of these visitors 618e have a purchase outcome.

FIG. 6D illustrates the results of an exemplary user query. Here, in response to a query of organic search as context 202, product, support, home and other experience 204 paths are provided. FIG. 6E illustrates a more complicated such query, where the query is made for all paths that lead to a particular outcome (e.g., cart add, cart remove), which in certain embodiments is displayed in differing colors or by isolation of given paths. The inventive analyses are performed for (1) any of the differing paths between nodes (i.e., visitor/user segments), or entire paths from context 202 to experience 204, and then to outcome 206 (i.e., visitor/user journeys).

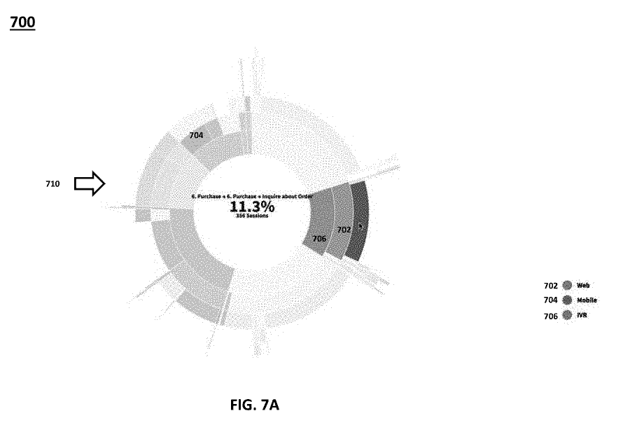

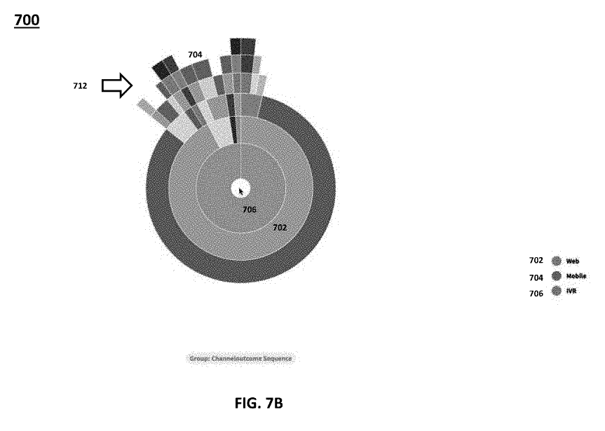

In exemplary embodiments, the inventive system permits a visual query permitting selection of a single node, and display of all path segments following the user's journey in concentric rings. For example, FIG. 7A-7C show path and segment analysis diagrams 700. In FIG. 7A, in response to queries by the data scientist, path segments are shown, and mapped to differing platform/channels (e.g., web 702, mobile 704, IVR 706). In the particular embodiment shown, in response to a query, the path segments for users who made a first purchase, then a second purchase, and then inquired about the order are shown, mapped with the channels. In greyed out color area 710, channels not relevant to the inquiry (e.g., mobile 704) are displayed in exemplary embodiments. FIG. 7B provides the same illustration in schematic format. Additional queries can be made by selection of any particular area of the concentric circles; this has the effect of making the selected area the center of the circle, and the segments that follow the selection the new concentric rings of a new circle. The query can be repeated outward from the initial circle, or inward, any number of times, to provide additional information about the users' journeys.

In FIG. 7C, a session journey platform 710 provides the data scientist (or other user of the inventive embodiments) the ability to query and display multiple visualizations of the modeled data. In the particular example, the interactive visualization is for a selected geographical location and/or country. As shown, in this example the context 202 includes SEO (search engine optimization), affiliate, SEM (search engine marketing), display and paid social, each mapped to volume of interacting users for such context. The experiences 204 include international, my account, other, payment, product, promotions, search, shipping, start checkout and support, visually displayed in an interactive concentric ring fashion. The outputs 206 include bounce, browse, product view, cart add, cart remove and purchase, each mapped to volumes of interacting users for such relevant outcome. With the concentric ring visualization of experience 204, any of the color-coded experiences can be selected, which will reveal in concentric ring fashion all of the segments following such selection along the journey toward an outcome. Exemplary display 716 illustrates information about the adequacy of support offered, providing exemplary user categories for users who continually selected the support page. Display 714 provides a display of the metrics of time, as against the outcomes of cart addition, cart removal, total volumes of users, and session identifies for the users' sessions.

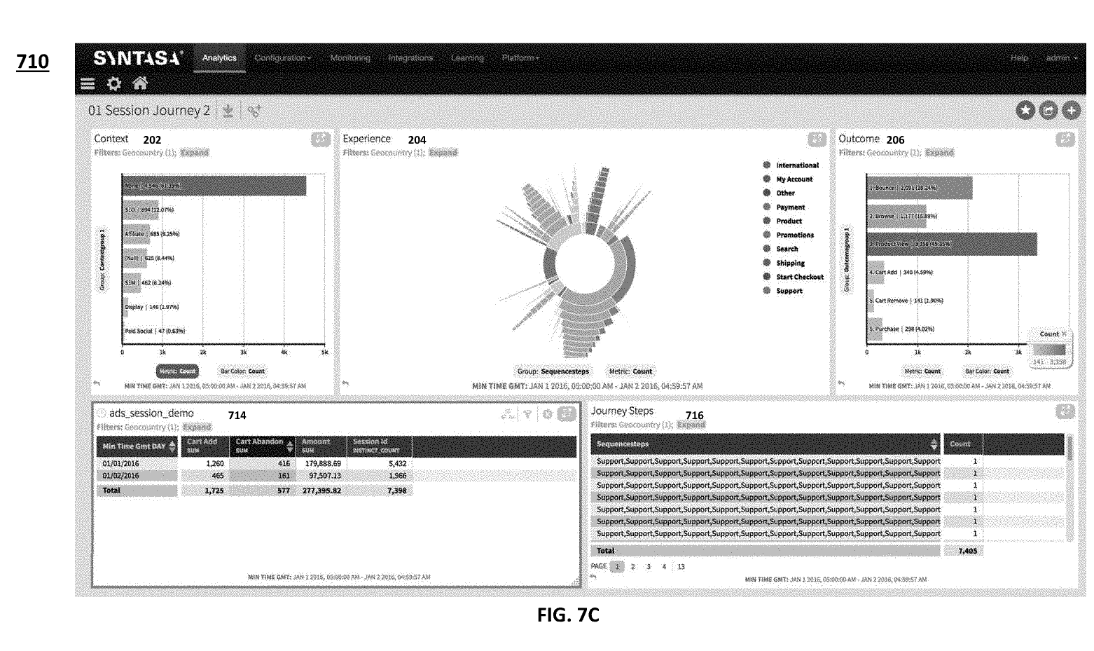

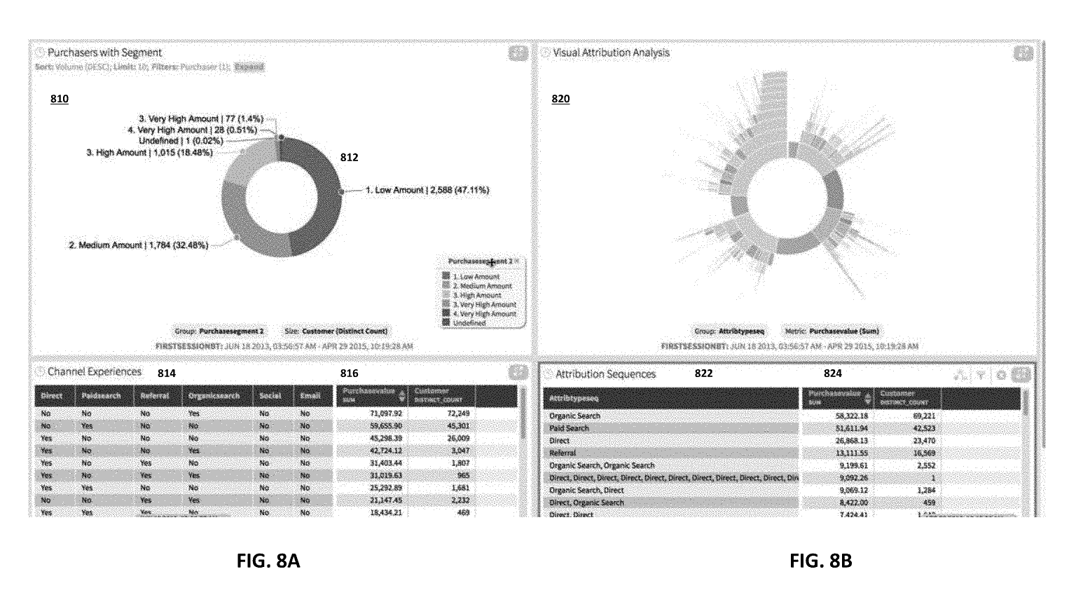

In FIG. 8A, session journey platform 810 provides the data scientist (or other user of the inventive embodiments) the ability to query and display modeling of the volume of purchase segments. This is provided in the exemplary embodiment in color coded fashion with a single concentric ring 812, and also via channel experiences 814 for context 202 mapped against purchase values and the volume of users 816. Similarly, in FIG. 8B, session journey platform 820 provides the data scientist (or other user of the inventive embodiments) the ability to query, model and visualize in a similar concentric fashion the volume of purchase segments via visual attribution sequences. Here, each attribution sequence comprises one or more contexts 204 visited by users, and mapped in sequential fashion; this is shown as concentric rings for visualization, and also as a mapping of attribution sequences 822, against purchase values and the volume of users 824.

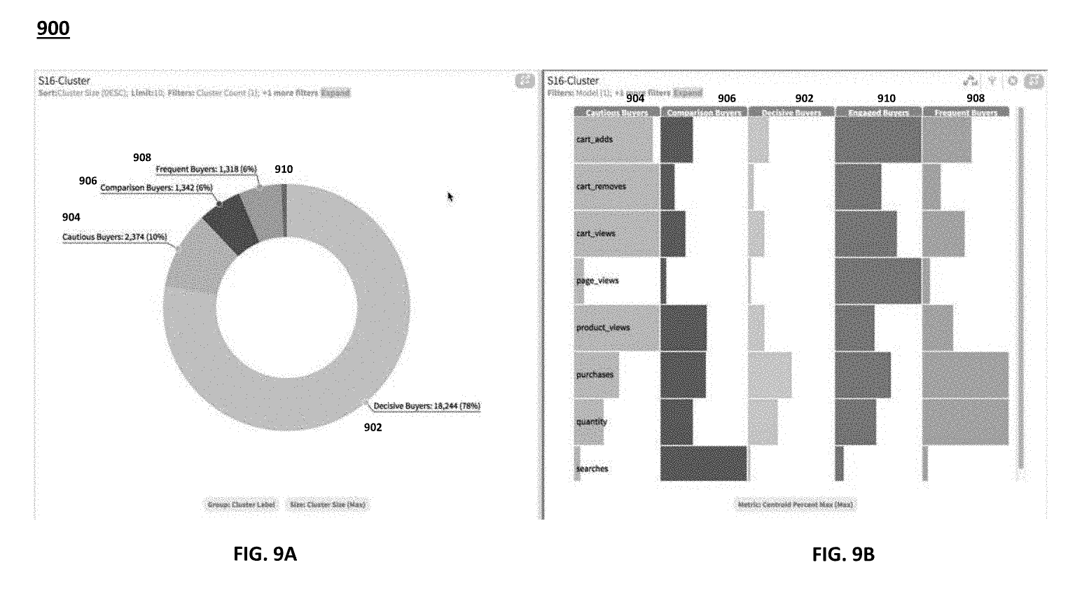

As above taught, the inventive embodiments include predictive analytics and processing of metrics/data by application of learning algorithms, which may also be visualized for the data scientist (or other user of the inventive embodiments). FIG. 9A, for example, illustrates the results of an exemplary k-means clustering algorithm applied to the data of data lake 454 of Hadoop cluster 450. The algorithm applies a distance measure to minimize the distance between data points in clusters to group the data into five groups. In the illustrated embodiment, the cluster algorithm is applied based on identification of the user as a type of buyer (though this type is not to be taken as limiting, and may include the type of shopper, inter alia). Based on the outcomes 206, these 5 groups are identified with the following descriptive categories: decisive buyers 902, cautious buyers 904, comparison buyers 906, frequent buyers 908 and engaged buyers 910. The size of each category 902-910 along the circle represents the proportional volume of the category, with the entire circle representing 100% of volume.

In FIG. 9B, each type of buyer category 902-910 is normalized relative to the entire volume in a category, and identified by the outcome 206 of the category. In fact, in an exemplary embodiment, once the clustering is performed, and the data is normalized as shown, it is these outcomes 206 for each category 902-910 that enables the data scientist to label such outcome. For example, the cautious buyers 904 exhibit proportionally high volumes of cart additions, cart removals and product views in relation to the purchases made; on the other hand, the frequent buyers 908 exhibit very high volumes of purchases in comparison to the relatively small number of cart additions, removals and views.

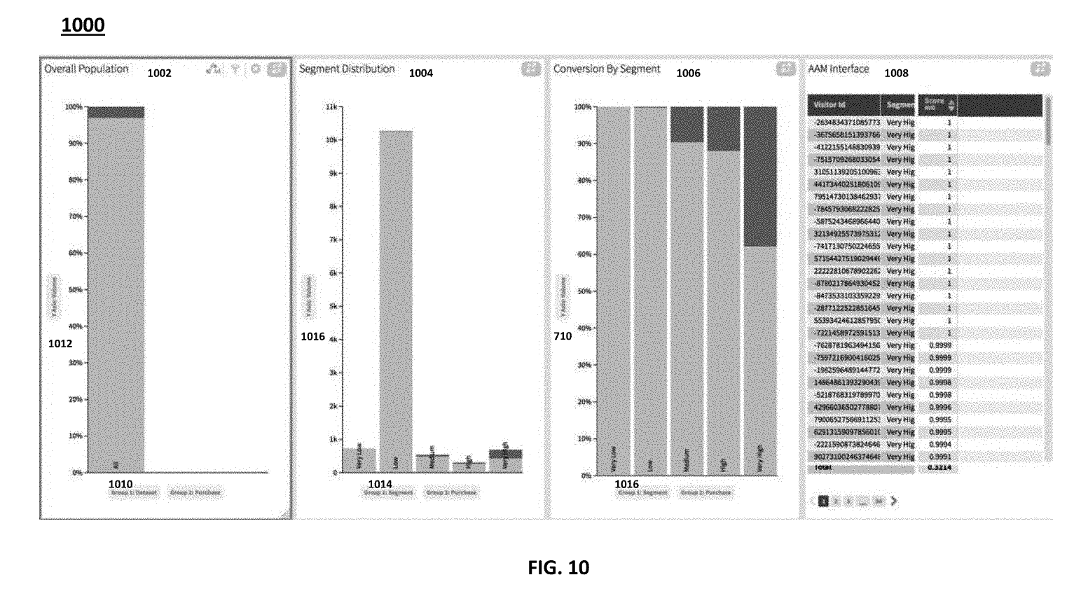

FIG. 10, data abstractions 1000 are used to segment (i.e., cluster) users into relevant categories for additional marketing efforts made based on relevance; in exemplary embodiments, additional marketing efforts, including algorithmic retargeting, are made on users belonging to specific categories of highest relevance. Interactive output 1002 graphs percentage output for the overall population; the dataset of the entire population (group 1), and the purchasing users (group 2) are mapped as percentages, with the darker color showing the purchase percentage. Interactive output 1004 provides a segmentation of the users into five categories, namely very low, low, medium, high and very high (group 1), and maps the volume for each category, with the darker color representing the users who made purchases. Interactive output 1006 is the same as output 1004, except that it shows the purchases made, in dark color, as a percentage (i.e., conversions made) of the overall volume for each such segment. Interactive output 1008 displays exemplary extracted data for algorithmic retargeting via an exemplary AAM (Adobe Audience Manager) interface, including identification of the user (i.e., visitor id), the aforementioned segmentation information, and a score assigned by the system.

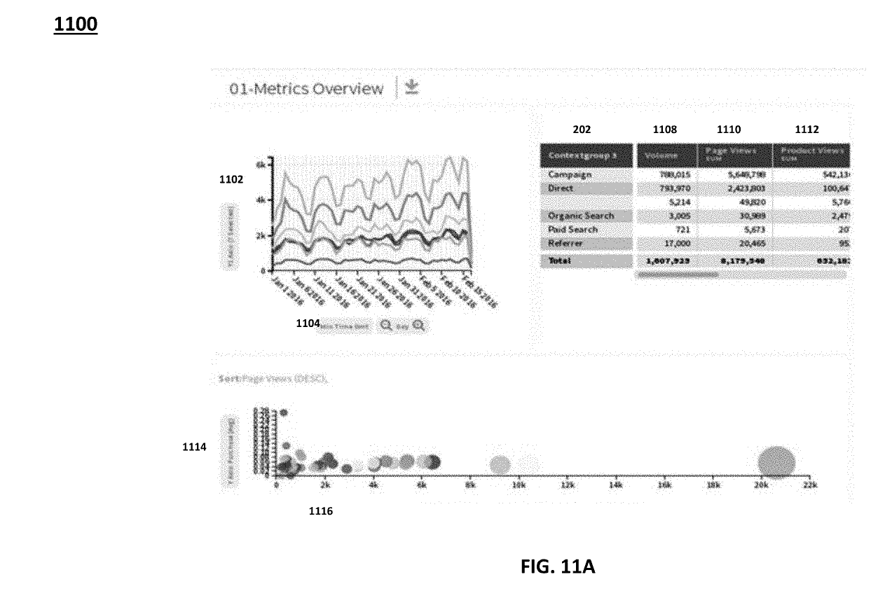

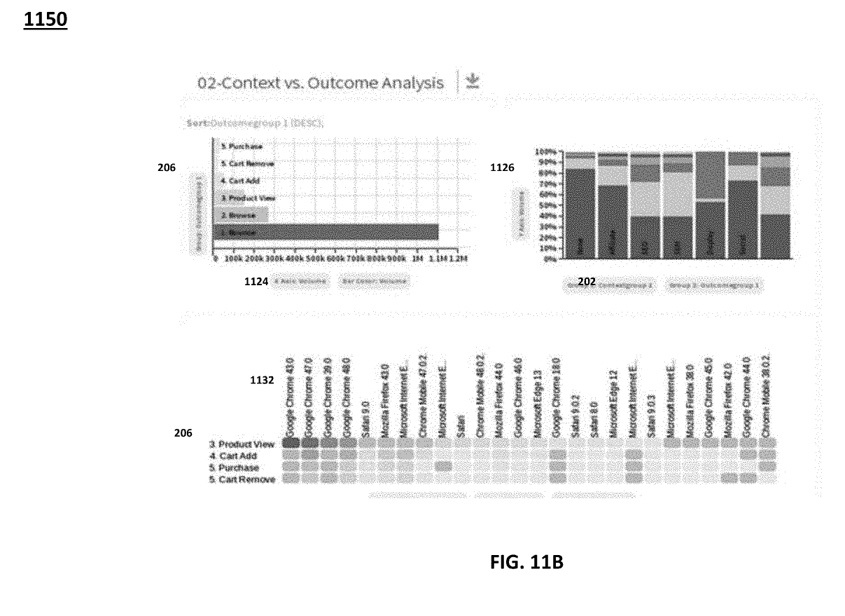

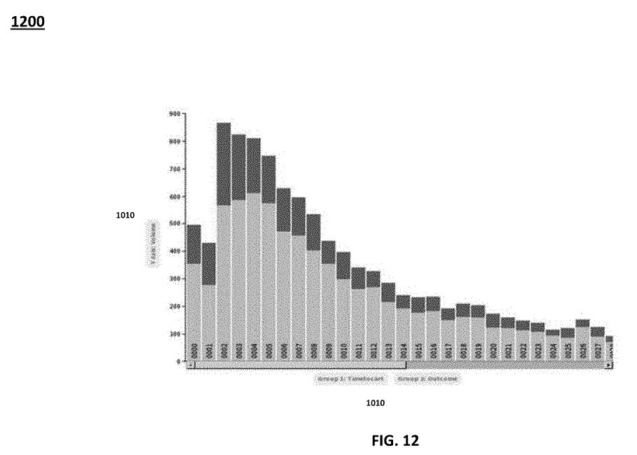

FIGS. 11A, 11B and 12 illustrate the virtually limitless garnering of useful information permitted by the inventive embodiments. In reference to FIG. 11A, interactive mapping 1100 may be readily performed for: (1) time 1104 versus any desired dataset 1102; (2) context groups 202 mapped for volume 1108, page views 1110, and product views (i.e., experience 204, and/or outcome 206). In reference to FIG. 11B, interactive mapping 1150 may be readily performed for: (1) outcomes 206 in total volume 1124; (2) context groups 202 mapped by volume 1126 for one or more categories; and (3) outcomes 202 mapped for specific types of contexts and/or experiences 1132. FIG. 12 provides an exemplary interactive mapping for time to cart segmented outcomes 1010, listed by volume.

Exemplary Hardware/Software Embodiments

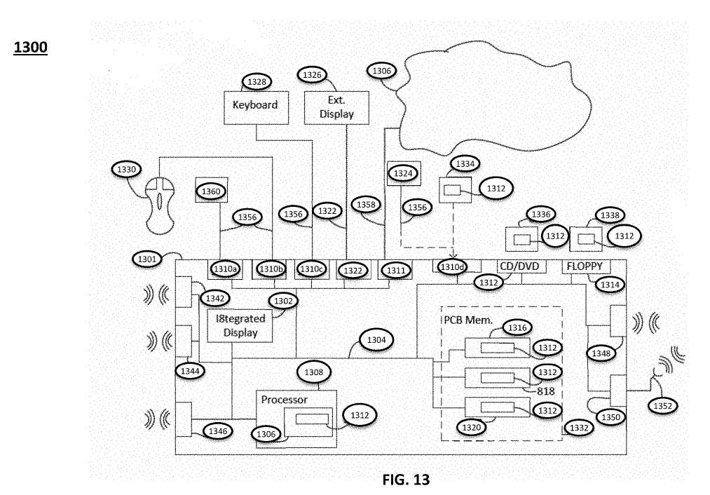

FIG. 13 illustrates an exemplary hardware and software embodiment 1300 to illustrate the interoperability of hardware and software components of exemplary enterprise analytics processor 434 (shown in FIG. 4A).

Enterprise analytics processor 434 includes, among other items, shell/box 1301, internal data/command bus (bus) 1304, processor(s) 1308 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 1310, compact disk (CD)/digital video disk (DVD) read/write (R/W) drive 1312, floppy diskette drive 1314 (though less used currently, many servers still include this device), and data storage unit 1332. According to further aspects of the embodiments, a controller can be used in place or, or in conjunction with processor 1308, wherein the controller can include one or more hardware components designed and/or fabricated to replicate the functionality of processor 1308. According to still further aspects of the embodiments, processor 1308 and a controller can be used interchangeably or in combination to perform the processing functions described herein.

Data storage unit 1332 itself can comprise hard disk drive (HDD) 1316 (these can include conventional magnetic storage media, but, as is becoming increasingly more prevalent, can include flash drive-type mass storage devices 1334, among other types), read-only memory (ROM) device(s) 1318 (these can include electrically erasable (EE) programmable ROM (EEPROM) devices, ultra-violet erasable PROM devices (UVPROMs), among other types), and random access memory (RAM) devices 1320. Usable with USB port 1310 is flash drive device 1334, and usable with CD/DVD R/W device 1312 are CD/DVD disks 1336 (which can be both read and write-able). Usable with floppy diskette drive device 1314 are floppy diskettes 1338. Each of the memory storage devices, or the memory storage media (1316, 1318, 1320, 1334, 1336, and 1338, among other types), can contain parts or components, or in its entirety, executable software programming code or application (application, or “App”) analytics App 1312, which can implement part or all of the portions of method 500 described herein. Further, processor 1308 itself can contain one or different types of memory storage devices (most probably, but not in a limiting manner, RAM memory storage media 1320) that can store all or some of the components of behavioral analytics App 1312.

In addition to the above described components, enterprise analytics processor 434 also comprises user console 1324, which can include keyboard 1328, display 1326, and mouse 1330. All of these components are known to those of ordinary skill in the art, and this description includes all known and future variants of these types of devices. Display 1326 can be any type of known display or presentation screen, such as liquid crystal displays (LCDs), light emitting diode displays (LEDs), plasma displays, cathode ray tubes (CRTs), among others. User console 1324 can include one or more user interface mechanisms such as a mouse, keyboard, microphone, touch pad, touch screen, voice-recognition system, among other inter-active inter-communicative devices.

User console 1324, and its components if separately provided, interface with enterprise analytics processor 434 via server input/output (I/O) interface 1322, which can be an RS232, Ethernet, USB or other type of communications port, or can include all or some of these, and further includes any other type of communications means, presently known or further developed. Enterprise analytics processor 434 can further include communications satellite/global positioning system (satellite) transceiver device 1350 to which is electrically connected at least one antenna 1352 (according to an embodiment, there can be at least one GPS receive-only antenna, and at least one separate satellite bi-directional communications antenna). Enterprise analytics processor 434 can access the Internet, either through a hard wired connection, via I/O interface 1322 directly, or wirelessly via Wi-Fi transceiver 1342, 3G/4G transceiver 1348 and/or satellite transceiver device 1350 (and their respective antennas) according to an embodiment. Enterprise analytics processor 434 can also be part of a larger network configuration as in a global area network (GAN) (e.g., the Internet), which ultimately allows connection to various landlines.

According to further embodiments, user console 1324 provides a means for personnel to enter commands and configuration into enterprise analytics processor 434 (e.g., via a keyboard, buttons, switches, touch screen and/or joy stick). Display device 1326 can be used to show visual representations of acquired data, and the status of applications that can be running, among other things.

Bus 1304 provides a data/command pathway for items such as: the transfer and storage of data/commands between processor 1308, Wi-Fi transceiver 1342, BT transceiver 1344, NFC transceiver 1346, internal display 1302, I/O port 1322, USB port 1310, CD/DVD drive 1312, floppy diskette drive 1314, memory 1332, 3G/4G transceiver 1348 and satellite transceiver device 1350. Through bus 1304, data can be accessed that is stored in data storage unit memory 1332. Processor 1308 can send information for visual display to display 1326, and the user can send commands to system operating programs/software/Apps that might reside in either processor 1308.

Enterprise analytics processor 434, and either memory 1306 or memory 1332, can be used to implement method 500 for modeling interaction between an individual and an entity according to aspects of the embodiments. Hardware, firmware, software or a combination thereof can be used to perform the various steps and operations described herein. According to an embodiment, App 1312 for carrying out the above discussed steps can be stored and distributed on multi-media storage devices such as devices 1316, 1318, 1320, 1334, 1336 and/or 1338 (described above) or other form of media capable of portably storing information, and storage media 1334, 1336 and/or 1338 can be inserted into, and read by, devices such as USB port 1310, CD-ROM drive 1312, and disk drives 1314, 1316, among other types of software storage devices.

As also will be appreciated by one skilled in the art, the various functional aspects of the embodiments can be embodied in any combination of channels, protocols, platforms or technologies. Accordingly, the embodiments can take the form of an entirely hardware embodiment or an embodiment combining hardware and software aspects. Further, the embodiments can take the form of a non-transitory computer program product stored on a computer-readable storage medium having computer-readable instructions embodied in the medium. Any suitable computer-readable medium can be utilized, including hard disks, CD-ROMs, digital versatile discs (DVDs), optical storage devices, or magnetic storage devices such a floppy disk or magnetic tape. Other non-limiting examples of computer-readable media include flash-type memories or other known types of memories.

Further, those of ordinary skill in the art in the field of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed, and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or nonvolatile memory such as read only memory (ROM) and/or random access memory (RAM). A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable, volatile/nonvolatile, and transitory/non-transitory computer storage media. For example, the processor can access a hard disk drive that reads from or writes to non-removable, nonvolatile, and non-transitory magnetic media, a magnetic disk drive that reads from or writes to a removable, nonvolatile, and non-transitory magnetic disk, and/or an optical disk drive that reads from or writes to a removable, nonvolatile, and non-transitory optical disk, such as a CD-ROM or other optical media. Other removable/non-removable, volatile/nonvolatile, and non-transitory computer storage media that can be used in the operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The embodiments discussed herein can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the embodiments pertains.

Exemplary Network Embodiments

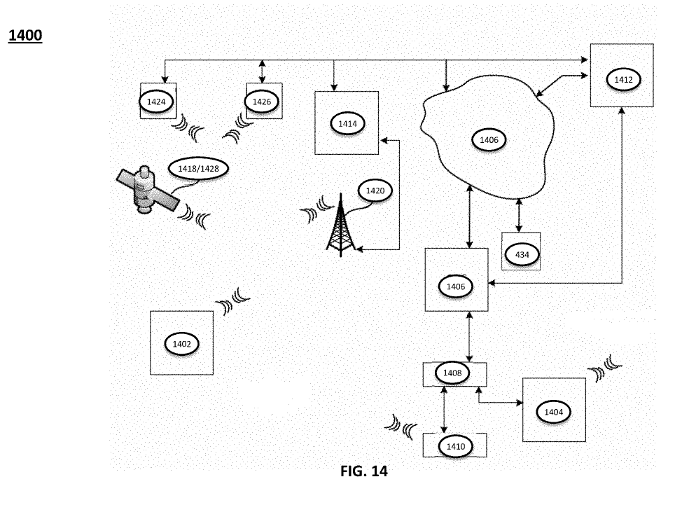

FIG. 14 illustrates exemplary network system infrastructure 1400 for communications between relevant platforms, channels, applications and other elements according to certain embodiments. For example, APIs 410, 416 (shown in FIG. 4A) and paths 412, 414 respectfully communicate between enterprise applications processor 434 and cloud 420, and between cloud 420 and one or more client devices, according to these embodiments.

Much of network system infrastructure 1400 as shown in FIG. 14 is or should be known to those of skill in the art, so, in fulfillment of the dual purposes of clarity and brevity, a detailed discussion thereof shall be omitted.

In network system infrastructure 1400 , the user has mobile device 1402, which can access cellular service provider 1414, either through a wireless connection (cellular tower X20) or via a wireless/wired interconnection (a “Wi-Fi” system that comprises, e.g., modulator/demodulator (modem) 1408, wireless router 1410, network access device 1404, internet service provider (ISP) 1406, and network 1406). Further, mobile device 1402 can include near field communication (NFC), “Wi-Fi,” and Bluetooth (BT) communications capabilities as well, all of which are known to those of skill in the art. To that end, network system 1400 further includes, as many homes (and businesses) do, one or more network access devices 1404 that can be connected to wireless router 1410 via a wired connection (e.g., modem 1408) or via a wireless connection (e.g., Bluetooth). Modem 1408 can be connected to ISP 1406 to provide internet based communications in the appropriate format to end users (e.g., network access device 1404), and which takes signals from the end users and forwards them to ISP 1406. Such communication pathways are well known and understand by those of skill in the art, and a further detailed discussion thereof is therefore unnecessary.

Mobile device 1402 can also access global positioning system (GPS) satellite 1428, which is controlled by GPS station 1424, to obtain positioning information (which can be useful for different aspects of the embodiments), or mobile device 1402 can obtain positioning information via cellular service provider 1414 using cell tower(s) 1420 according to one or more well-known methods of position determination. Some mobile devices 1402 can also access communication satellites 1418 and their respective satellite communication systems control stations 1426 (the satellite in FIG. 14 is shown common to both communications and GPS functions) for near-universal communications capabilities, albeit at a much higher cost than convention “terrestrial” cellular services. Mobile device 1402 can also obtain positioning information when near or internal to a building (or arena/stadium) through the use of one or more of NFC/BT devices, the details of which are known to those of skill in the art. FIG. 14 also illustrates other components of network system 1400 such as plain old telephone service (POTS) provider 1412.

According to further aspects of the embodiments, network system 1400 also contains enterprise analytics processor 434, where one or more processors, using known and understood technology, such as memory, data and instruction buses, and other electronic devices, can store and implement code that can implement the aforementioned systems and methods.

An encoding process can also be employed with certain embodiments. The encoding process is not meant to limit the aspects of the embodiments, or to suggest that the aspects of the embodiments should be implemented following the encoding process.

In exemplary embodiments, a source array, computer software, and methods are employed for conducting the operations of enterprise analytics processor 434. It should be understood that these descriptions are not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments can be practiced without such specific details.

Non-Limiting Nature of Described Embodiments

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and can include other examples that occur to those skilled in the art. Such other examples are intended to be within the scope of the claims.

The above-described embodiments are intended to be illustrative in all respects, rather than restrictive, of the embodiments. Thus, the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

We claim:

1. A method for determining one or more analytics schema for interactions of one or more users with an online channel, the method comprising:
determining one or more experiences for the users for the interactions based upon at least one of: one or more web analytics data, and one or more enterprise analytics data;
determining a behavioral analytics schema for the users based on hierarchical data extraction analyses of at least one of said web analytics data through web analytics data analyses, and said enterprise analytics data through enterprise analytics data analyses; and
reporting the behavioral analysis schema in response to a query.

2. The method according to claim 1, further comprising:
determining one or more contexts for the users, a said context being defined by one or more attributes pertaining to any one of: the users; and the activities of the users, antedating the interactions of the users with the channel,
wherein the behavioral analytics schema is further based on analyses of the contexts.

3. The method according to claim 2, further comprising:
determining one or more outcomes for the users, a said outcome being a defined result pertaining to the activities of the users following the experience determining step and prior to completion of the interactions for a given visit of the online channel,
wherein the behavioral analytics schema is further based on analyses of the outcomes.

4. The method according to claim 3, further comprising:
determining a predictive analytics schema for the users predicting future interactions of the users with the online channel, the predictive analytics schema being based on application of learning processes to the behavioral analytics schema; and
reporting the predictive analytics schema in response to any one of a said query and another query.

5. The method according to claim 2, wherein any one of determining a said experience and determining a said context comprises determining in relation to a said user one or more metrics relating to at least one of:
a previously visited channel;
a geographical location of a said user;
a marketing campaign of an entity marketing to a said user;
an advertising campaign of an entity marketing to a said user;
a paid search leading to access of said channel;
an organic search leading to access of said channel;
a direct access of said channel;
a device type employed to access said channel;
a platform type employed to access said channel;
any one of a date and a time of said visit of said channel;
a loyalty program employed;
an incentive program employed;
a customer profile information of a said user; and
a class information of a said user.

6. The method according to claim 1, wherein said web analytics data analyses comprise determining web analytics information for a said user during the interactions, and
wherein said enterprise analytics data analyses comprise determining an enterprise analytics information for at least one of a said user and an enterprise entity related information.

7. The method according to claim 6, wherein said web analytics data comprises at least one of:
a click data for the users;
a clickstream data for the users;
a page views data for the users;
a unique visitors data for the users;
a referral sources data for the users;
a bounce pages data for the users;
a site searching data for the users; and
an errors logged for the users.

8. The method according to claim 6, wherein said enterprise analytics information comprises at least one of:
a customer relationship management (CRM) data;
an emails data;
an enterprise resource planning data;
a loyalty programs data;
an incentive programs data;
a product inventories data;
a call centers data;
a location based information data;
a site area data;
a mobile apps data;
an interactive voice response (IVR) information data;
a products/services data;
an ecommerce data;
an information gathering data; and
an inventory data.

9. The method according to claim 3, wherein determining a said outcome comprises determining at least one of:
a bounce of a said user from the channel;
a browse by a said user of the channel;
a product view by a said user on the channel;
a cart addition by a said user on the channel;
a cart removal of a said user on the channel; and
a purchase of a product by a said user on the channel.

10. The method according to claim 9, wherein determining the behavioral analytics schema for the users comprises at least one of:
(i) modeling the behavior of the users by tracing a clickstream data garnered from a said web analytics analysis, said modeling comprising tracing each segment of the clickstream data, and each path comprising the entirety of the clickstream data, from a said context to a said experience and further to a said outcome;
(ii) modeling the behavior of the users by clustering the users into one or more cluster groups with each said cluster group indicating any one of a buying behavior classification and a shopping behavior classification on the online channel, and further segmenting each said cluster group based on a said outcome;
(iii) modeling the behavior of the users by performing said step (i) for at least one of one or more additional channels and one or more additional platforms;
(iv) modeling the behavior of the users by segmenting one or more parameters related to a said outcome based on a time measurement, and mapping said segmented parameters based on any one of a volume of sales, a number of page views, and a number of product views, on the channel;
(v) modeling the behavior of the users by mapping of (1) said one or more metrics, said metrics relating to any one of a said experience and a said context, in relation to (2) another metric based on a said outcome, said another metric being at least one of a volume of sales, a number of page views, and a number of product views, on the channel; and
(vi) modeling the behavior of the users by segmentation of a distribution of an entire population of the users based on one or more factors relating to one or more of said outcomes, to enable conducting of algorithmic retargeting of the users based on said segmentation.

11. The method according to claim 10, wherein determining the predictive analytics schema in relation to any one of said steps (i) through (vi) comprises configuring and applying one or more learning models.

12. The method according to claim 11, wherein any one of the reporting of the behavioral analysis schema and the reporting of the predictive analytics schema comprises a visualization via a graphical user interface of any one of steps (i) through (vi).

13. A system for determining one or more analytics schema for interactions of one or more users with an online channel, the system comprising one or more applications executed by one or more processors, said applications comprising:
applications operable to determine one or more experiences for the users for the interactions based upon at least one of: one or more web analytics data, and one or more enterprise analytics data;
applications operable to determine a behavioral analytics schema for the users based on hierarchical data extraction analyses of at least one of said web analytics data through web analytics data analyses, and said enterprise analytics data through enterprise analytics data analyses; and
a reporting device operable to report the behavioral analysis schema in response to a query.

14. The system according to claim 13, further comprising:
applications operable to determine one or more contexts for the users, a said context being defined by one or more attributes pertaining to any one of: the users; and the activities of the users, antedating the interactions of the users with the channel,
wherein the behavioral analytics schema is further based on analyses of the contexts.

15. The system according to claim 14, further comprising:
applications operable to determine one or more outcomes for the users, a said outcome being a defined result pertaining to the activities of the users following the experience determining step and prior to completion of the interactions for a given visit of the online channel,
wherein the behavioral analytics schema is further based on analyses of the outcomes.

16. The system according to claim 15, further comprising:
applications operable to determine a predictive analytics schema for the users predicting future interactions of the users with the online channel, the predictive analytics schema being based on application of learning processes to the behavioral analytics schema; and
a reporting device operable to report the predictive analytics schema in response to any one of a said query and another query.

17. The system according to claim 14, wherein any one of determining a said experience and determining a said context comprises determining in relation to a said user one or more metrics relating to at least one of:
a previously visited channel;
a geographical location of a said user;
a marketing campaign of an entity marketing to a said user;
an advertising campaign of an entity marketing to a said user;
a paid search leading to access of said channel;
an organic search leading to access of said channel;
a direct access of said channel;
a device type employed to access said channel;
a platform type employed to access said channel;
any one of a date and a time of said visit of said channel;
a loyalty program employed;
an incentive program employed;
a customer profile information of a said user; and
a class information of a said user.

18. The system according to claim 13, wherein said web analytics data analyses comprise determining web analytics information for a said user during the interactions, and wherein said enterprise analytics data analyses comprise determining an enterprise analytics information for at least one of a said user and an enterprise entity related information.

19. The system according to claim 18, wherein said web analytics data comprises at least one of:
a click data for the users;
a clickstream data for the users;
a page views data for the users;
a unique visitors data for the users;
a referral sources data for the users;
a bounce pages data for the users;
a site searching data for the users; and
an errors logged for the users.

20. The system according to claim 18, wherein said enterprise analytics information comprises at least one of:
a customer relationship management (CRM) data;
an emails data;
an enterprise resource planning data;
a loyalty programs data;
an incentive programs data;
a product inventories data;
a call centers data;
a location based information data;
a site area data;
a mobile apps data;
an interactive voice response (IVR) information data;
a products/services data;
an ecommerce data;
an information gathering data; and
an inventory data.

21. The system according to claim 15, wherein determining a said outcome comprises determining at least one of:
a bounce of a said user from the channel;
a browse by a said user of the channel;
a product view by a said user on the channel;
a cart addition by a said user on the channel;
a cart removal of a said user on the channel; and
a purchase of a product by a said user on the channel.

22. The system according to claim 21, wherein determining the behavioral analytics schema for the users comprises at least one of:
(i) modeling the behavior of the users by tracing a clickstream data garnered from a said web analytics analysis, said modeling comprising tracing each segment of the clickstream data, and each path comprising the entirety of the clickstream data, from a said context to a said experience and further to a said outcome;
(ii) modeling the behavior of the users by clustering the users into one or more cluster groups with each said cluster group indicating any one of a buying behavior classification and a shopping behavior classification on the online channel, and further segmenting each said cluster group based on a said outcome;
(iii) modeling the behavior of the users by performing said step (i) for at least one of one or more additional channels and one or more additional platforms;
(iv) modeling the behavior of the users by segmenting one or more parameters related to a said outcome based on a time measurement, and mapping said segmented parameters based on any one of a volume of sales, a number of page views, and a number of product views, on the channel;
(v) modeling the behavior of the users by mapping of (1) said one or more metrics, said metrics relating to any one of a said experience and a said context, in relation to (2) another metric based on a said outcome, said another metric being at least one of a volume of sales, a number of page views, and a number of product views, on the channel; and
(vi) modeling the behavior of the users by segmentation of a distribution of an entire population of the users based on one or more factors relating to one or more of said outcomes, to enable conducting of algorithmic retargeting of the users based on said segmentation.

23. The system according to claim 22, wherein determining the predictive analytics schema in relation to any one of said steps (i) through (vi) comprises configuring and applying one or more learning models.

24. The system according to claim 23, wherein any one of the reporting of the behavioral analysis schema and the reporting of the predictive analytics schema comprises a visualization via a graphical user interface of any one of steps (i) through (vi).
